(19) United States
(12) Patent Application Publication
(10) Pub. No.: US 2012/0159629 A1
(43) Pub. Date: Jun. 21, 2012

(54) METHOD AND SYSTEM FOR DETECTING MALICIOUS SCRIPT

(75) Inventors: Hahn-Ming Lee, New Taipei City (TW); Jerome Yeh, Taipei City (TW); Hung-Chang Chen, New Taipei City (TW); Ching-Hao Mao, Taipei City (TW)

(73) Assignee: National Taiwan University of Science and Technology, Taipei (TW)

(21) Appl. No.: 13/165,787

(22) Filed: Jun. 21, 2011

(30) Foreign Application Priority Data
Dec. 16, 2010 (TW) 99144307

(51) Int. Cl. G06F 11/00

(52) U.S. Cl. 726/24

(57) ABSTRACT

A method for detecting a malicious script is provided. A plurality of distribution eigenvalues are generated according to a plurality of function names of a web script. After the distribution eigenvalues are inputted to a hidden markov model (HMM), probabilities respectively corresponding to a normal state and an abnormal state are calculated. Accordingly, whether the web script is malicious or not can be determined according to the probabilities. Even an attacker attempts to change the event order, insert a new event or replace an event with a new one to avoid detection, the method can still recognize the intent hidden in the web script by using the HMM for event modeling. As such, the method may be applied in detection of obfuscated malicious scripts.

### CROSS-REFERENCE TO RELATED APPLICATION

This application claims the priority benefit of Taiwan application serial no. 99144307, filed on Dec. 16, 2010. The entirety of the above-mentioned patent application is hereby incorporated by reference herein and made a part of this specification.

### BACKGROUND OF THE INVENTION

1. Field of the Invention

The present invention relates to methods and systems for detecting network attack, and more particularly, to a method and system for detecting a malicious script.

2. Description of Related Art

In 2004, hackers were first found to take advantage of vulnerabilities in web applications to perform so called cross-site-script attack, which mainly take advantage of site vulnerabilities to import malicious program to attack web explorers and conduct malicious behavior such as downloading and executing malicious files. In IEEE international conference on engineering of complex computer (ICECCS) 2005, Oystein Hallaraker et al proposed to prevent the attack by using SandBox technology. The SandBox observes the malicious script behavior and defines the rules of normal and attack behaviors in terms of script keywords. However, the SandBox technology is not good at detection of obfuscated malicious scripts.

Currently, anti-virus software detects malicious scripts mainly by characteristics comparison. As a result, the malicious script can avoid anti-virus detection once the hacker performs a fuzzy processing on the characteristics. Therefore, the anti-virus software cannot effectively detect malicious scripts.

### SUMMARY OF THE INVENTION

Accordingly, the present invention is directed to a method and a system for detecting a malicious script which can effectively detect a malicious script.

A method for detecting a malicious script is provided. In this method, a web script is first received. A plurality of function names of the web script is then extracted. A plurality of distribution eigenvalues is generated according to the function names. Afterwards, the distribution eigenvalues are inputted into a hidden markov model (HMM) which defines a normal state and an abnormal state. The HMM then calculates a first probability and a second probability according to the distribution eigenvalues. The first probability and the second probability correspond to the normal state and the abnormal state, respectively. Whether the web script is malicious is determined according to the first probability and the second probability.

In one embodiment, after determining whether the web script is malicious, the method further includes issuing and storing a warning message.

In one embodiment, before receiving the web script, the method further includes receiving a plurality of training scripts; extracting a plurality of training function names of the training scripts; calculating a plurality of training distribution eigenvalues according to the training function names; determining a plurality of transition probability parameters and a plurality of emission probability parameters of the HMM according to the training distribution eigenvalues; and establishing the HMM according to the transition probability parameters and the emission probability parameters.

In one embodiment, determining the transition probability parameters and the emission probability parameters includes using a counting rule and conditional probability to calculate the transition probability parameters and the emission probability parameters.

In one embodiment, calculating the first probability and the second probability includes using a forward algorithm to sum up the probabilities of the distribution eigenvalues corresponding to the normal state and the abnormal state.

A system for detecting a malicious script is also provided. The system includes a web script collector, a script function extractor, and an abnormal state detector. The web script collector receives a web script. The script function extractor extracts a plurality of function names of the web script and generates a plurality of distribution eigenvalues according to the function names. The abnormal state detector inputs the distribution eigenvalues into a hidden markov model (HMM) so as to use the HMM to calculate a first probability and a second probability according to the distribution eigenvalues, thereby determining whether the web script is malicious. The HMM defines a normal state and an abnormal state, and the first probability and the second probability correspond to the normal state and the abnormal state, respectively.

In one embodiment, the abnormal state detector further issues a warning message, and the malicious script detecting system further includes a warning message database storing the warning message.

In one embodiment, the web script collector further receives a plurality of training scripts. The script function extractor extracts a plurality of training function names of the training scripts and calculates a plurality of training distribution eigenvalues. The malicious script detecting system further includes a model parameter estimator and a model generator. The model parameter estimator determines a plurality of transition probability parameters and a plurality of emission probability parameters of the HMM according to the training distribution eigenvalues. The model generator establishes the HMM according to the transition probability parameters and the emission probability parameters.

In one embodiment, the model parameter estimator uses a counting rule and conditional probability to calculate the transition probability parameters and the emission probability parameters.

In one embodiment, the abnormal state detector uses a forward algorithm to sum up the probabilities of the distribution eigenvalues according to the normal state and the abnormal state to calculate the first probability and the second probability.

In view of the foregoing, the present malicious script detecting method and system can analyze the probabilities at different state of the functions' execution timing in the web script by using the HMM, thereby determining whether the web script is malicious.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a block diagram illustrating a system for detecting a malicious script according to one embodiment of the present invention.

FIG. 2 is a flow chart of a method for detecting a malicious script according to one embodiment of the present invention.

FIG. 3 is a block diagram illustrating a system for detecting a malicious script according to another embodiment of the present invention.

FIG. 4 is a flow chart of a method for detecting a malicious script according to another embodiment of the present invention.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts.

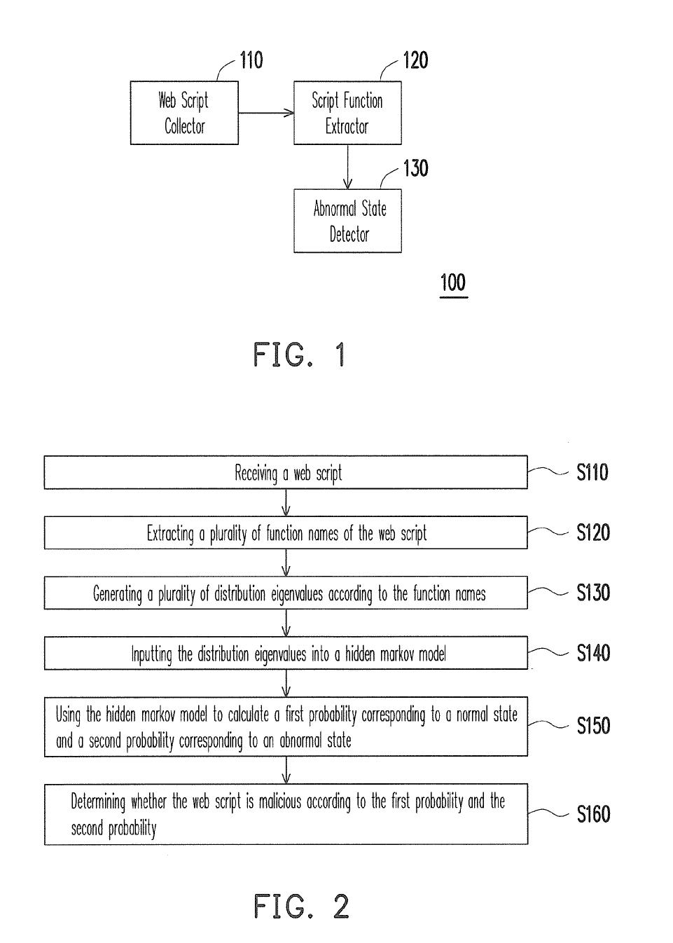

FIG. 1 is a block diagram illustrating a system for detecting a malicious script according to one embodiment of the present invention. Referring to FIG. 1, the malicious script detecting system 100 includes a web script collector 110, a script function extractor 120, and an abnormal state detector 130. The web script collector 110 is coupled to the script function extractor 120, and the script function extractor 120 is coupled to the abnormal state detector 130.

FIG. 2 is a flow chart of a method for detecting a malicious script according to one embodiment of the present invention. The method flow chart of FIG. 2 is described below in conjunction with the malicious script detecting system 100 of FIG. 1. It is noted, however, that the detecting method described herein is illustrative rather than limiting. Firstly, the web script collector 110 receives a web script at step S110. In the present embodiment, the web script may be written using a scripting language such as Java script. At step S120, the script function extractor 120 extracts a plurality of function names of the web script. At step S130, the script function extractor 120 generates a plurality of distribution eigenvalues according to the function names. These function names may be predefined depending upon the scripting language.

At step S140, the abnormal state detector 130 inputs the distribution eigenvalues into a hidden markov model (HMM). At step S150, the abnormal state detector 130 uses the HMM to calculate a first probability and a second probability from the distribution eigenvalues. At step S160, the abnormal state detector 130 determines whether or not the web script is a malicious script according to the first probability and the second probability. In the present embodiment, the HMM defines a normal state and an abnormal state, and the first probability and the second probability correspond to the normal state and the abnormal state, respectively. In another embodiment not illustrated, the HMM may define more states depending upon a different attack.

It is noted that the functions in the web script are executed in an order that varies with different behaviors. Therefore, in the present embodiment, the HMM performs a sequence analysis on the function names distributed in the codes, thereby effectively analyzing the network behavior of the web script. As such, it can be successfully determined whether the web script is malicious or not.

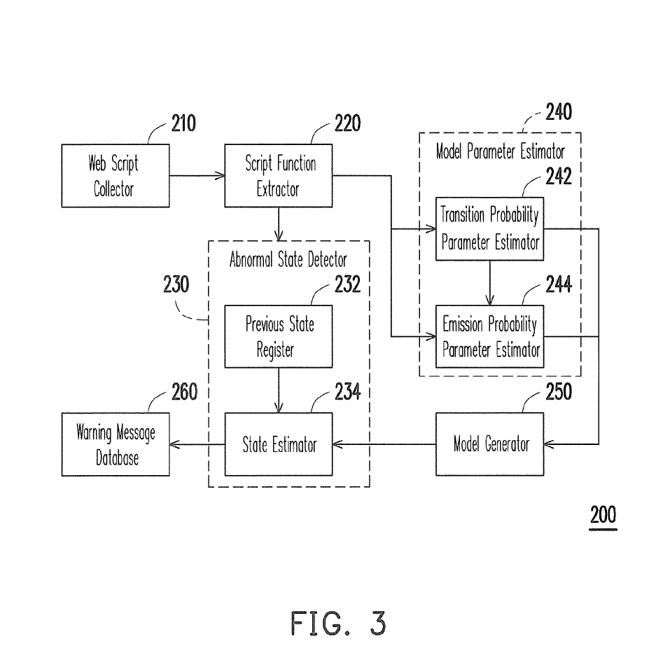

FIG. 3 is a block diagram illustrating a system for detecting a malicious script according to another embodiment of the present invention. Referring to FIG. 1 and FIG. 3, in comparison with the malicious script detecting system 100, the malicious script detecting system 200 further includes a model parameter estimator 240, a model generator 250, and a warning message database 260. The model parameter estimator 240 is coupled to the script function extractor 220 and the model generator 250, and the abnormal state detector 230 is coupled to the model generator 250 and the warning message database 260.

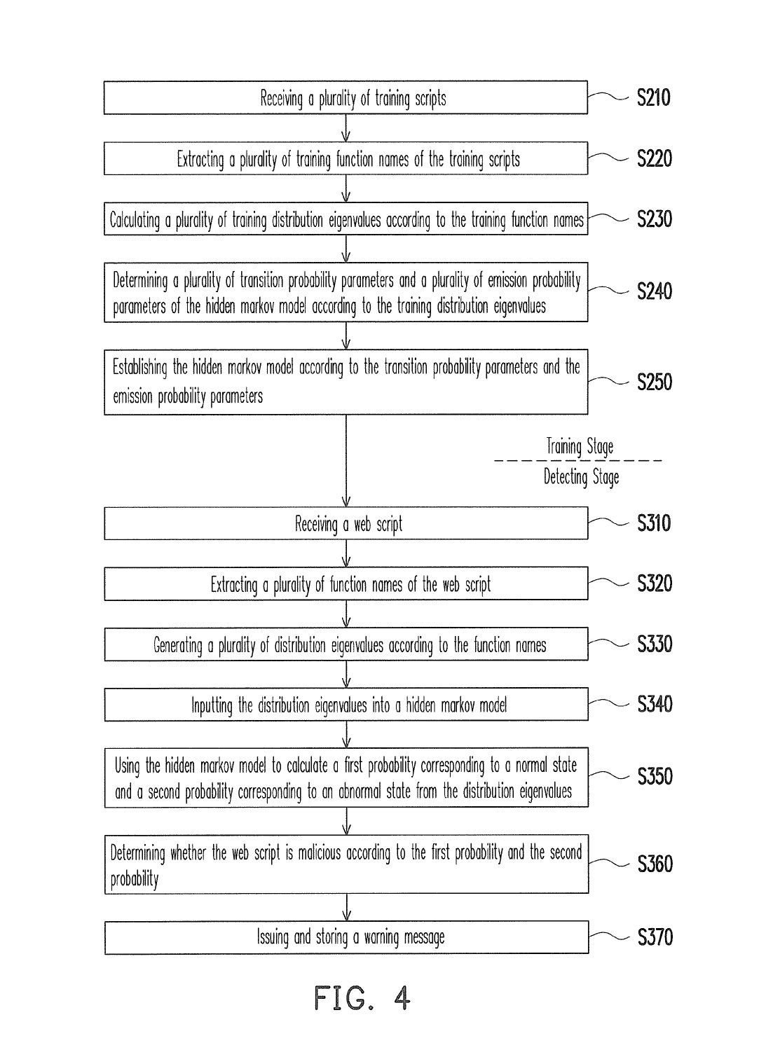

FIG. 4 is a flow chart of a method for detecting a malicious script according to another embodiment of the present invention. The flow chart of FIG. 4 generally includes a training stage for establishing HMM (steps S210 to S250) and a detecting stage for detecting malicious scripts (steps S310 to S370). The training stage and detecting stage of FIG. 4 are sequentially described below in conjunction with the malicious script detecting system 200 of FIG. 3. It is noted, however, that the training stage and detecting stage described herein are illustrative rather than limiting. Referring to FIG. 3 and FIG. 4, at step S210, the web script collector 210 first receives a plurality of training scripts. At step S220, the script function extractor 220 then extracts multiple training function names of the training scripts. At step S230, the script function extractor 220 calculates a plurality of training distribution eigenvalues according to the training function names. There may be two types of training distribution eigenvalues, one being the distribution values of the respective function name, the other one being the distribution values between the function names and the state.

At step S240, the model parameter estimator 240 determines multiple transition probability parameters and multiple emission probability parameters of the HMM according to the training distribution eigenvalues. In the present embodiment, the model parameter estimator 240 may include a transition probability estimator 242 and an emission probability estimator 244. The transition probability parameter estimator 242 calculates the transition probabilities of transition between predefined states to generate transition probability parameters according to the training distribution eigenvalues. For example, the transition probability parameter estimator 242 may use conditional probability in combination with statistical counting rule to sequentially calculate the ratio of state category of each instance's behavior in the entire training set. The ratio calculated by the transition probability parameter estimator 242 is the transition probability of that corresponding instance.

In addition, the emission probability parameter estimator 244 calculates the probabilities of the training distribution eigenvalues complying with each predefined state to thereby generate the emission probability parameters. For example, the emission probability parameter estimator 244 may use the conditional probability in combination with the statistical counting rule to calculate the probability of an eigenvector extracted from each instance corresponding to the behavior states. At step S250, the model generator 250 then establishes the probability sequence model of HMM according to the transition probability parameters and emission probability parameters in combination with the script behavior's state categories such as the predefined normal state and abnormal state.

As described above, the model parameter estimator 240 and the model generator 250 operate in the training stage and generate the probability sequence model of HMM for use in subsequent malicious script detection according to the collected web scripts. The detecting stage is performed upon completion of the training stage. At step S310, the web script collector 210 first receives a web script. At step S320, the script function extractor 220 then extracts a plurality of function names of the web script. At step S330, the script function extractor 220 generates a plurality of distribution eigenvalues according to the function names. The function names may be predefined depending upon the scripting language.

Then, at step S340, the abnormal state detector 230 inputs the distribution eigenvalues into an HMM. At step S350, the abnormal stage detector 230 uses the HMM to calculate a first probability and a second probability from the distribution eigenvalues. In the present embodiment, the abnormal stage detector 230 may use a forward algorithm to sum up the probabilities of the distribution eigenvalues corresponding to the normal state and abnormal state.

Specifically, the abnormal state detector 230 may include a previous state register 232 and a state estimator 234. The script function extractor 220 inputs the distribution eigenvalues of the function names and the behavior state categories of the previous function names into the state estimator 234. The state estimator 234 then determines the probabilities (first probability and second probability) corresponding to the behavior states of the respective predefined script functions in the HMM according to the function name distribution eigenvalues and the behavior state categories of the previous script function names.

In the present embodiment, the state estimator 234 may use the forward algorithm to sum up the eigenvalue probabilities of the respective script functions calculated by the HMM. After summing up the probabilities, the state estimator 234 can thus calculate the probability of the behavior state of the current script function corresponding to each predefined behavior state. The state estimator 234 then determines whether the behavior state of the current script function is of a category that needs warning according to the calculated probability and temporarily stores this behavior state category in the previous state register 232. The web function behavior state categories temporarily stored in the previous state register 232 can be provided to the state estimator 234 for calculating the probabilities of respective web script behavior states for a next web script function.

At step S360, the abnormal state detector 230 determines whether the web script is malicious or not according to the first probability and the second probability. For example, the abnormal state detector 230 may determine whether the second probability corresponding to the abnormal behavior state of the function is larger than ½. If yes, the method proceeds to step S370 where the abnormal state detector 230 issues a warning message and stores the warning message in a warning message database 260 for later use.

In summary, the present malicious script detecting method and system can use the HMM to analyze the probabilities at different state of the functions' execution timing in the web script, thereby determining whether the web script is malicious. Therefore, the present method and system can be applied in detection of obfuscated malicious scripts. That is, the present method and system can detect a malicious web script that has been obfuscated and varied by a hacker. In addition, the present invention can detect and warn the user of the malicious web script before the user explores a web page, thereby reducing the cost of repairing the attacked web script.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter. In addition, any one of the embodiments or claims of the invention is not necessarily achieve all of the above-mentioned objectives, advantages or features. The abstract and the title herein are used to assist searching the documentations of the relevant patents, not to limit the claim scope of the invention.

What is claimed is:

1. A method for detecting a malicious script, comprising:
receiving a web script;
extracting a plurality of function names of the web script;
generating a plurality of distribution eigenvalues according to the function names;
inputting the distribution eigenvalues into a hidden markov model which defines a normal state and an abnormal state;
using the hidden markov model to calculate a first probability and a second probability according to the distribution eigenvalues, the first probability and the second probability corresponding to the normal state and the abnormal state, respectively; and
determining whether the web script is malicious according to the first probability and the second probability.

2. The method for detecting a malicious script according to claim 1, wherein, after determining whether the web script is malicious, the method further comprises issuing and storing a warning message.

3. The method for detecting a malicious script according to claim 1, wherein, before receiving the web script, the method further comprises:
receiving a plurality of training scripts;
extracting a plurality of training function names of the training scripts;
calculating a plurality of training distribution eigenvalues according to the training function names;
determining a plurality of transition probability parameters and a plurality of emission probability parameters of the hidden markov model according to the training distribution eigenvalues; and
establishing the hidden markov model according to the transition probability parameters and the emission probability parameters.

4. The method for detecting a malicious script according to claim 3, wherein determining the transition probability parameters and the emission probability parameters comprises using a counting rule and conditional probability to calculate the transition probability parameters and the emission probability parameters.

5. The method for detecting a malicious script according to claim 1, wherein calculating the first probability and the second probability comprises using a forward algorithm to sum up the probabilities of the distribution eigenvalues corresponding to the normal state and the abnormal state.

6. A system for detecting a malicious script, comprising:
a web script collector for receiving a web script;
a script function extractor for extracting a plurality of function names of the web script and generating a plurality of distribution eigenvalues according to the function names; and
an abnormal state detector adapted to input the distribution eigenvalues into a hidden markov model so as to use the hidden markov model to calculate a first probability and a second probability according to the distribution eigenvalues to thereby determine whether the web script is malicious, wherein the hidden markov model defines a normal state and an abnormal state, and the first probability and the second probability correspond to the normal state and the abnormal state, respectively.

7. The system for detecting a malicious script according to claim 6, wherein the abnormal state detector is adapted to further issue a warning message, and the malicious script detecting system further includes a warning message database storing the warning message.

8. The system for detecting a malicious script according to claim 6, wherein the web script collector further receives a plurality of training scripts, and the script function extractor extracts a plurality of training function names of the training scripts and calculates a plurality of training distribution eigenvalues, and the malicious script detecting system further comprises:
a model parameter estimator for determining a plurality of transition probability parameters and a plurality of emission probability parameters of the hidden markov model according to the training distribution eigenvalues; and
a model generator for establishing the hidden markov model according to the transition probability parameters and the emission probability parameters.

9. The system for detecting a malicious script according to claim 8, wherein the model parameter estimator uses a counting rule and conditional probability to calculate the transition probability parameters and the emission probability parameters.

10. The system for detecting a malicious script according to claim 6, wherein the abnormal state detector uses a forward algorithm to sum up the probabilities of the distribution eigenvalues corresponding to the normal state and the abnormal state to calculate the first probability and the second probability.
